(19) United States
(12) Patent Application Publication
(10) Pub. No.: US 2007/0049301 A1
(43) Pub. Date: Mar. 1, 2007

(54) Articulating emotional response to messages

(75) Inventors: Von A. Mock, Boynton Beach, FL (US); Jose E. Korneluk, Boynton Beach, FL (US)

Correspondence Address: CUENOT & FORSYTHE, L.L.C., 12230 FOREST HILL BLVD., SUITE 120, WELLINGTON, FL, 33414, US

(73) Assignee: Motorola, Inc.

(21) Appl. No.: 11/215,462

(22) Filed: Aug. 30, 2005

(51) Int. Cl. H04L 12/58; H04Q 7/20; H04Q 7/22; H04M 1/725

(52) U.S. Cl. 455/466; 455/412.1

(57) ABSTRACT

A method (1000) and a communication device (120) for articulating an emotional response from a first user to a second user. The communication device can include a positioning system (230) that senses a rotational input received by the communication device or an orientation of the communication device, and generates corresponding input parameter. The positioning system can determine an amount of rotation of the communication device or determine the direction in which the communication device is oriented. The device also can include a processor (220) that correlates the input parameter to an indicator message (130) and a network adapter (210) that forwards the indicator message from the communication device to a second communication device (140). The indicator message can represent an emotional state of a user and can include a Chernoff face, one or more images, a sound token, a color, a vibration sequence or a text message.

### BACKGROUND OF THE INVENTION

1. Field of the Invention

The present invention generally relates to communications and, more particularly, to messaging services.

2. Background of the Invention

Mobile communication devices, such as mobile telephones and personal digital assistants (PDAs), are becoming ubiquitous throughout much of the world. Indeed, many people consider such devices an essential part of modern living. Spurring their adoption by consumers is a wide range of functionality now being designed into the devices. For instance, mobile communication devices that include computer applications, Internet access and text messaging are now available.

Using text messaging functions on some communication devices, such as mobile telephones, can be tedious, however. Indeed, a user typically uses a numeric keypad to enter text into a message, and often is required to depress particular keys multiple times for each letter of the alphabet to be included in the message. Accordingly, generating a simple text message can be both inconvenient and time consuming. Accordingly, a solution is needed to improve the messaging functionality of mobile communication devices.

### SUMMARY OF THE INVENTION

The present invention relates to a method and a communication device that quickly and easily articulates an emotional response from a first user to a second user over a communications network. The communication device can include a positioning system senses a rotational input received by the communication device or an orientation of the communication device. Accordingly, the positioning system can determine an amount of rotation of the communication device or determine the direction in which the communication device is oriented, and generate corresponding input parameter. For example, the direction in which the communication device (first communication device) is oriented can be compared to a direction of a location of a second communication device with respect to the first communication device. In another arrangement, the direction in which the first communication device is oriented can be compared to an initial orientation of the first communication device or a direction of a compass heading.

The device also can include a processor that correlates the input parameter to an indicator message and a network adapter that forwards the indicator message from the first communication device to the second communication device. The indicator message can represent an emotional state of a user of the first communication device and can include a Chernoff face, a sound token, a color, a vibration sequence and/or a text message.

The method can include the step of sensing a rotational input received by a first communication device or an orientation of the first communication device, and generating a corresponding input parameter. The input parameter can be correlated to an indicator message. For example, the input parameter can correspond to an amount of rotation of the first communication device, which can be correlated to the indicator message.

In another arrangement, a direction in which the first communication device is oriented can be correlated to the indicator message. For example, an orientation of the first communication device with respect to the second communication device can be determined. The orientation of the first communication device also can be determined with respect to an initial orientation of the first communication device. Alternatively, an orientation of the first communication device with respect to a direction of a compass heading can be determined.

The message indicator that is selected can be a Chernoff face, one or more images, a sound token, a color, a vibration sequence and/or a text message, and can represent of an emotional state of a user of the first communication device.

Another embodiment of the present invention can include a machine readable storage being programmed to cause a machine to perform the various steps described herein.

### BRIEF DESCRIPTION OF THE DRAWINGS

Preferred embodiments of the present invention will be described below in more detail, with reference to the accompanying drawings, in which:

FIG. 1 depicts a communications system that is useful for understanding the present invention.

FIG. 2 is a block diagram of a communication device that is useful for understanding the present invention.

FIG. 3 is a diagram depicting polar coordinates that are useful for understanding the present invention.

FIGS. 4-9 present a plurality of vibration force v. time plots that are useful for understanding the present invention.

FIG. 10 is a flowchart useful for understanding the present invention.

### DETAILED DESCRIPTION

While the specification concludes with claims defining the features of the invention that are regarded as novel, it is believed that the invention will be better understood from a consideration of the following description in conjunction with the drawings, in which like reference numerals are carried forward.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

FIG. 1 depicts a communications system 100 that is useful for understanding the present invention. The present invention relates to a method and a system for quickly and easily articulating an emotional response from a first user to a second user over a communications network 110. In particular, a rotational input received by a first communication device 120 or an orientation of the first communication 120 device can be sensed to generate a corresponding input parameter. An indicator message 130 correlating to the input parameter then can be transmitted from the first communication device 120 to a second communication device 140 that is used by the second user.

For instance, if the first user is happy, the first user can rotate or orient the first communication device 120 in a manner that will reflect that the first user is happy, and the indicator message 130 can contain corresponding data. If the first user is concerned or angry, the first communication device 120 can be rotated or oriented in a manner that represents such states, and again the indicator message 130 can include corresponding data. The first communication device 120 can be manipulated in the hand of the first user, or the first user can move her hand in an arc or circular pattern to rotate the communication device. The first user also can turn her body until the first communication device 120 has been properly rotated in an arc or circular direction, or is in the proper orientation to send the desired indicator message 130. Rotation of the user's body to select a message containing an indication of emotion can be very intuitive.

The message that corresponds to the current orientation or rotation of the first communication device can be presented to the first user on a display 150. For example, as the first communication device 120 is rotated from a first orientation to a second orientation, the message presented on the display 150 can be changed from a first indicator message to a second indicator message. When the indicator message 130 that the first user desires to send is shown on the display 150, the first user can initiate transmission of the desired message. For example, the user can depress a key or button, tap a touch pad, squeeze the first communication device 120, utter a command, or signal the first communication device 120 to send the desired indicator message 130 in any other suitable manner. Accordingly, the first user can quickly and easily communicate her emotional state to the second user, without requiring the first user to enter text or navigate through menu selections using keys or buttons.

The communications network 110 can include landline and/or wireless communication links. For example, the communications network 1 10 can be a direct communications link between the first and second communication devices 120, 140, a public switched telephone network (PSTN), a cellular telephone communications network, a mobile radio communications network, a telemetry system, a wide area network (WAN), a local area network (LAN), a wireless LAN (WLAN), an intranet, the Internet, or any other suitable communications network.

The first communication device 120 can be, for example, a telephone, a mobile telephone, a personal digital assistant (PDA), a computing device, or any other system or device that can communicate with the second communication device 140. Similarly, the second communication device can be a telephone, a mobile telephone, a PDA, a computing device, or any other system or device that can communicate with the first communication device 120.

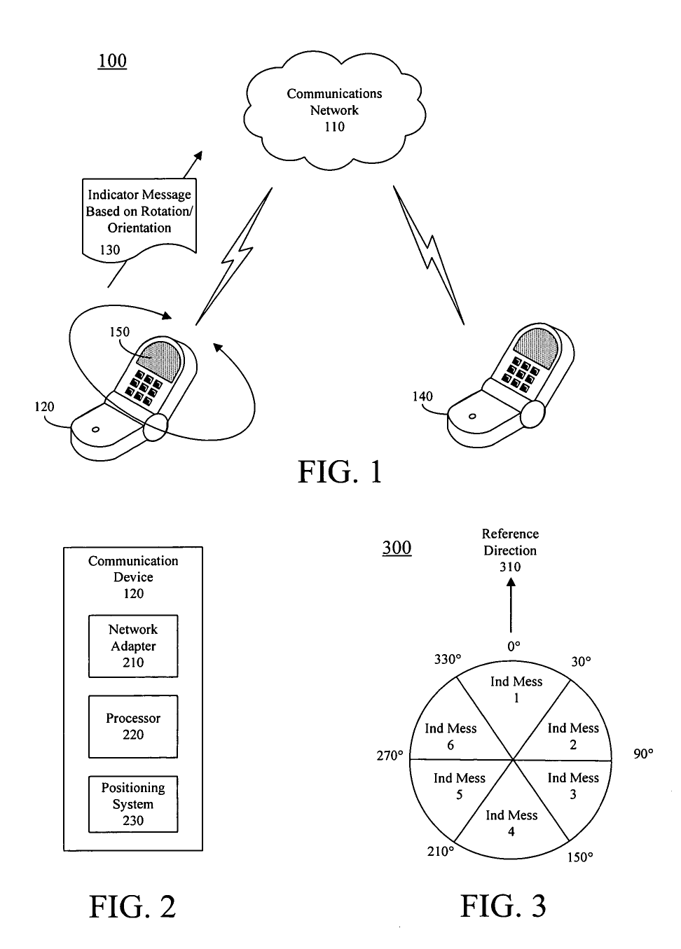

Referring to FIG. 2, a block diagram of the first communication device 120 is depicted. The first communication device 120 can include a network adapter 210. The network adapter 210 can be a wired network adapter, a wireless network adapter, a transceiver, or any other device components suitable for transmitting the indicator message to the second communication device. For example, if the communication device 120 is a conventional wired telephone, the network adapter 210 can be a conventional telephone line interface. If the communication device 120 communicates via a cellular communications network, the network adapter 210 can be a transceiver. If the communication device 120 communicates via a WLAN or LAN, then the network adapter 210 can be a WLAN or LAN network adapter. Still, a myriad of other network adapters are known to the skilled artisan and the invention is not limited in this regard.

The communication device 120 also can include a processor 220. The processor 220 can include a central processing unit (CPU), a digital signal processor (DSP), an application specific integrated circuit (ASIC), a programmable logic device (PLD), and/or any other suitable processing device.

In addition, the communication device can include a positioning system 230. The positioning system can include any device suitable for detecting an orientation of the communication device 120 and/or suitable for detecting a rotation of the communication device 120. For instance, if the indicator message is selected based on the orientation of the communication device 120, the positioning system 230 can include a compass. The compass can be an electronic compass, a mechanical compass, an electromechanical compass, or any other suitable compass. A compass also can be used in conjunction with the processor 220 to determine an amount of rotation of the communication device 120. For example, the compass can forward orientation data to the processor 230, and the processor 230 can detect a change in the orientation data that correlates to a particular amount of rotation.

In another arrangement, the positioning system 230 can include an accelerometer. The accelerometer can be used to detect changes in the orientation of the first communication device 120 and forward such changes to the processor 230. While the compass and accelerometer are examples of components that can be included in the positioning system 230, the invention is not limited in this regard and any other suitable components can be used.

The positioning system 230 also can include a globally positioning system (GPS) and/or a local positioning system. The GPS and/or the local positioning system can provide positional coordinates that represent the location of the first communication device 120. A GPS and/or local positioning system also can be provided with the second communication device to represent its coordinates.

As known to the skilled artisan, the GPS can communicate with global positioning satellites to determine the position of the position of the first communications device, for example using trilateration. In contrast to a GPS, to determine the location of the first communication device 120, the local positioning system can communicate with positioning instruments that are located within a building, a park, a city, or any other geographically defined region. For example, the positioning instruments can be provided with network access points or cellular base stations which are used in the communications system. The local positioning system can implement any suitable method of determining the location of the first communication device 120. For example, the local positioning system can implement trilateration.

FIG. 3 is a diagram depicting a polar coordinate system 300 that is useful for understanding operation of the first communication device. The orientation of the first communication device can be determined with respect to a reference direction 310, which in this example is indicated as being 0°. The reference direction 310 can be a direction of the second communication device with respect to the first communication device, a direction of an initial orientation of the first communication device, a direction of a compass heading, such as magnetic north, or any other any other direction that can used as a reference.

In an arrangement in which the reference direction 310 is the direction of the second communication device with respect to the first communication device, the position of the second communication device can be determined and compared to the position of the first communication device to determine the reference direction. For instance, positional coordinates that represent the position of the second communication device can be transmitted to the first communication device for processing.

By way of example, if the first communication device is oriented between 330° and 30° with respect to the reference direction 310, a first input parameter can be generated and a first indicator message that correlates to the first input parameter then can be automatically selected and transmitted to the second communication device. Similarly, if the first communication device is orientated between 30° and 90° when the indicator message is to be sent, a second input parameter can be generated, and a corresponding second indicator message can be automatically selected and transmitted to the second communication device.

Example messages useful for understanding the present invention are shown in Table 1. However, it should be noted that many other messages can be used and other emotions can be represented, and such messages are within the scope of the present invention.

TABLE 1

| Degrees with | Indicator | |
|---|---|---|
| respect to | Message | |
| reference direction | No. | Emotion contained in message |
| 330° to 30° | 1 | Thank you |
| 30° to 90° | 2 | Happy - made my day |
| 90° to 150° | 3 | Caring - slight worry |
| 150° to 210° | 4 | Concern |
| 210° to 270° | 5 | Strong feeling of displeasure |
| 270° to 330° | 6 | Anger |

The indicator message can contain data that corresponds to text, a Chernoff face, one or more images, a color, a ring tone, a vibration sequence, a sound token, or any other parameter that can communicates the desired message. For example, the message data can correspond to a dark blue color to relay a thank you, light blue to relate happy-made my day, orange for caring, green for concern, gray for a strong feeling of displeasure, and black for anger.

A sound token can be an audio data file that is used to generate an audio signal to the user. A Chernoff face can be an image representing a face having one or more adjustable facial characteristics. For instance, facial characteristics of the Chernoff face can be presented with expressions that articulate the message that the first user wishes to communicate. For example, the Chernoff face can be presented with a smile, a frown, eye brows that slant, or any other facial expressions which may be perceived by the second user.

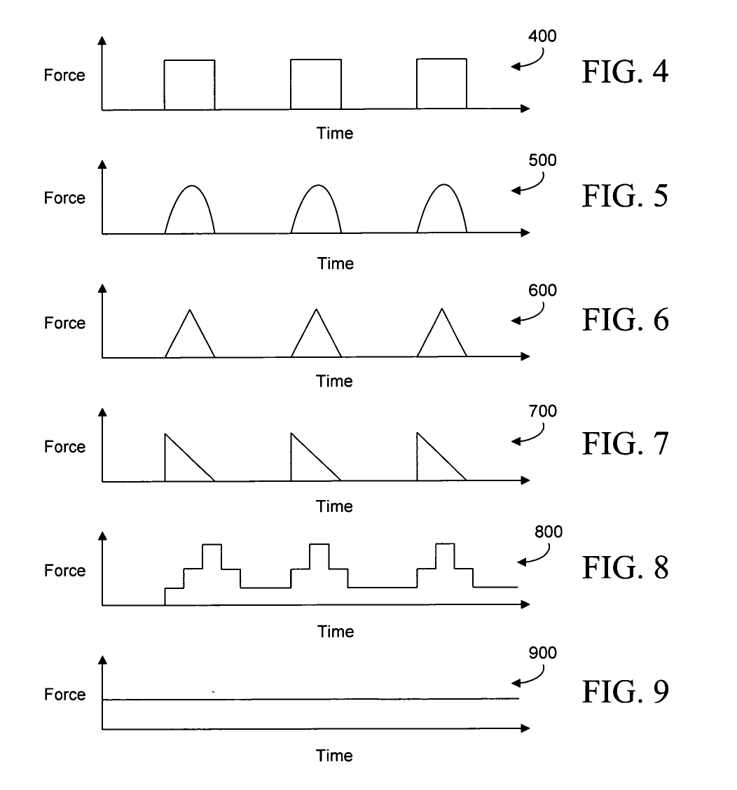

FIGS. 4-9 present a plurality of ‘vibration force’ versus ‘time’ plots that are useful for understanding the present invention. The various vibration patterns can be generated on the second communication device in response to the indicator message. Accordingly, the first user's message can be conveyed to the second user in a manner that is virtually silent, thus enabling the second user to discretely receive and comprehend the message. For example, plot 400 can represent a vibration pattern correlating to indicator message no. 1 presented in Table 1, plot 500 can represent a vibration patter correlating to indicator message no. 2, plot 600 can represent a vibration patter correlating to indicator message no. 3, plot 700 can represent a vibration patter correlating to indicator message no. 4, plot 800 can represent a vibration patter correlating to indicator message no. 5, and plot 900 can represent a vibration patter correlating to indicator message no. 6.

Nonetheless, the vibration patterns depicted are for example purposes only, and are not intended to limit the scope of the present invention. Indeed, a plethora of other vibration patterns can be used, and such other vibration patterns are within the scope of the present invention.

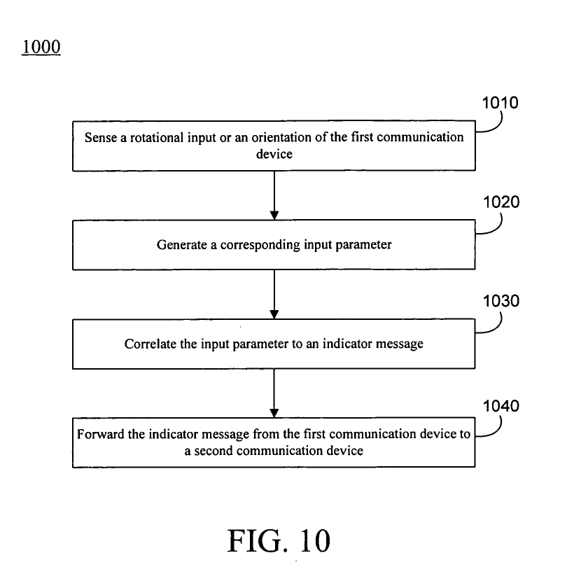

FIG. 10 is a flowchart of a method 1000 that is useful for understanding the present invention. Beginning at step 1010, a rotational input or an orientation of the first communication device can be sensed. For example, a manipulation of the communication device in hand or a movement of the communication device in an arc or circular pattern can be sensed. At step 1020, a corresponding input parameter can be generated, for example in response to a user input. Continuing to step 1030, the input parameter can be correlated to an indicator message. At step 1040, the indicator message can be forwarded from the first communication device to a second communication device. The indicator message can, for instance, articulate an emotional response of the first user.

The present invention can be realized in hardware, software, or a combination of hardware and software. The present invention can be realized in a centralized fashion in one system, or in a distributed fashion where different elements are spread across several interconnected systems. Any kind of processing device or other apparatus adapted for carrying out the methods described herein is suited. A typical combination of hardware and software can be a processing device with an application that, when being loaded and executed, controls the processing device such that it carries out the methods described herein.

The present invention also can be embedded in an application program product, which comprises all the features enabling the implementation of the methods described herein, and which when loaded in a processing device is able to carry out these methods. Application program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

What is claimed is:

1. A communication device comprising:
a positioning system that senses a rotational input received by the communication device or an orientation of the communication device, and generates corresponding input parameter;
a processor that correlates the input parameter to an indicator message; and
a network adapter that forwards the indicator message from the communication device (first communication device) to a second communication device.

2. The system of claim 1, wherein the positioning system determines an amount of rotation of the first communication device.

3. The system of claim 1, wherein the positioning system determines the direction in which the first communication device is oriented.

4. The system of claim 3, wherein the direction in which the first communication device is oriented is compared to a direction of a location of the second communication device with respect to the first communication device.

5. The system of claim 3, wherein the direction in which the first communication device is oriented is compared to an initial orientation of the first communication device or a direction of a compass heading.

6. The system of claim 1, wherein the indicator message comprises a Chernoff face, at least one image, a sound token, a color, a vibration sequence, or a text message.

7. The system of claim 1, wherein the indicator message represents an emotional state of a user of the first communication device.

8. A machine readable storage, having stored thereon a computer program having a plurality of code sections executable by a machine for causing the machine to perform the steps of:
sensing a rotational input received by a first communication device or an orientation of the first communication device, and generating a corresponding input parameter;
correlating the input parameter to an indicator message; and
forwarding the indicator message from the first communication device to a second communication device.

9. The machine readable storage of claim 8, wherein correlating the rotational input to the message indicator comprises determining an amount of rotation of the first communication device.

10. The machine readable storage of claim 8, wherein correlating the rotational input to the message indicator comprises determining a direction in which the first communication device is oriented.

11. The machine readable storage of claim 10, wherein determining a direction comprises identifying an orientation of the first communication device with respect to the second communication device.

12. The machine readable storage of claim 10, wherein determining a direction comprises identifying an orientation of the first communication device with respect to an initial orientation of the first communication device or a direction of a compass heading.

13. The machine readable storage of claim 8, wherein correlating the rotational input to the message indicator comprises selecting a Chernoff face, at least one image, a sound token, a color, a vibration sequence or a text message.

14. The machine readable storage of claim 8, wherein correlating the rotational input to the message indicator comprises identifying a representation of an emotional state of a user of the first communication device.

15. A method of communication comprising:
sensing a rotational input received by a first communication device or an orientation of the first communication device, and generating a corresponding input parameter;
correlating the input parameter to an indicator message; and
forwarding the indicator message from the first communication device to a second communication device.

16. The method according to claim 15, wherein correlating the rotational input to the message indicator comprises determining an amount of rotation of the first communication device.

17. The method according to claim 15, wherein correlating the rotational input to the message indicator comprises determining a direction in which the first communication device is oriented.

18. The method according to claim 17, wherein determining a direction comprises identifying an orientation of the first communication device with respect to the second communication device.

19. The method according to claim 17, wherein determining a direction comprises identifying an orientation of the first communication device with respect to an initial orientation of the first communication device or a direction of a compass heading.

20. The method according to claim 15, wherein correlating the rotational input to the message indicator comprises selecting a Chernoff face, at least one image, a sound token, a color, a vibration sequence or a text message.
